(19) United States
(12) Patent Application Publication
(10) Pub. No.: US 2012/0058045 A1
(43) Pub. Date: Mar. 8, 2012

(54) GAS FROM LANDFILL FOR USE IN HYDROGEN PRODUCTION

(76) Inventors: Michael Beckman, Redwood City, CA (US); Steven Eckhardt, Danville, CA (US); Rustam H. Sethna, Clinton, NJ (US)

(21) Appl. No.: 13/041,839

(22) Filed: Mar. 7, 2011

Related U.S. Application Data
(60) Provisional application No. 61/315,035, filed on Mar. 18, 2010.

(51) Int. Cl. C01B 3/26; B01J 19/00

(52) U.S. Cl. 423/652; 422/129

(57) ABSTRACT

Methane collected from a landfill is used as a feedstock for the production of hydrogen in a steam methane reformer. This invention provides a green energy feed stock for the hydrogen production that benefits the environment.

### CROSS-REFERENCE TO RELATED APPLICATIONS

This application claims priority from U.S. patent application Ser. No. 61/315,035 filed Mar. 18, 2010

### FIELD OF THE INVENTION

The present invention relates to methods and apparatus for using natural gas that has been recovered from a landfill as a feed stock for the production of hydrogen in a steam methane reformer (SMR).

### BACKGROUND OF THE INVENTION

When microbes act upon waste in a landfill, gas is created as a result of chemical reactions. The gas produced is primarily a mixture of methane and carbon dioxide, but can contain other elements, e.g. oxygen, nitrogen, sulfer, as well as contaminants associated with the waste. Because the landfill gas is being constantly produced, pressure can increase within the landfill to be ultimately released to the atmosphere, creating environmental concerns. In addition, the potential for explosions from migrating landfill gas and too much buildup leads to safety concerns.

Therefore there is a need to collect and dispose of the landfill gas to reduce the safety concerns as well as mitigate the environmental issues. The collected landfill gas is often disposed of by burning (or flaring). However, it is also possible to process the collected landfill gas into natural gas that can be used as a green fuel. To obtain the natural gas, the landfill gas must be purified to separate the methane from the other components of the landfill gas.

Methane reformers are devices used to produce pure hydrogen from natural gas, e.g. methane, and a catalyst, usually nickel. Steam methane reforming (SMR) processes expose the natural gas to the catalyst at high temperature and pressure using steam.

SMR employs an external source of gas to heated tubes in which a catalytic reaction takes place to convert steam and natural gas or methane, into hydrogen and carbon monoxide, known as syngas. The syngas reacts further with the steam to produce higher yields of syngas along with carbon dioxide as a by-product. The syngas is then treated to remove the carbon oxide impurities, such as by a pressure swing adsorption process, to provide the pure hydrogen product.

There remains a need for improvements to the process of forming hydrogen from natural gas.

### SUMMARY OF THE INVENTION

The present invention provides methods and apparatus of utilizing natural gas that has been recovered from a landfill as a feed stock for the production of hydrogen in an SMR. The present invention advantageously uses natural gas obtained from a landfill, thus reducing landfill emissions and also provides a consistent source of green fuel for producing pure hydrogen in an SMR.

### BRIEF DESCRIPTION OF THE DRAWINGS

FIG. 1 is a schematic drawing of an apparatus in accordance with one embodiment of the present invention.

### DETAILED DESCRIPTION OF THE INVENTION

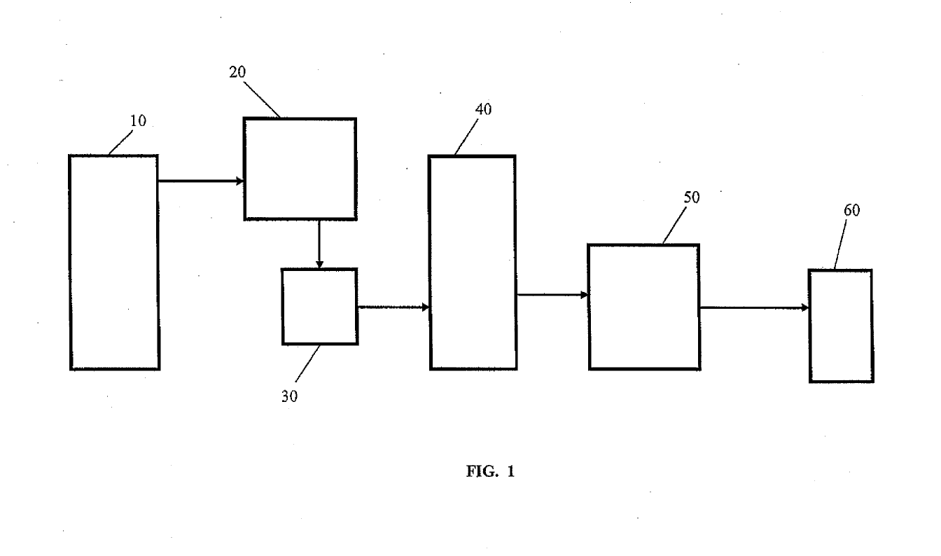

The present invention relates to methods and apparatus of utilizing natural gas recovered from a landfill as a feed stock for the production of hydrogen in an SMR. The invention will be described in more detail with reference to FIG. 1.

FIG. 1 is a schematic drawing of an apparatus according to one embodiment of the present invention. In particular, FIG. 1 shows a collection vessel (10) for holding landfill gas collected from a landfill. The landfill gas is then treated in a process operation (20) to separate and purify the methane. The purified methane can then be used with out compression or may be compressed in a compressor (30) to produce liquid natural gas (LNG). In either case the methane or LNG can be stored prior to use in a storage vessel (40). The purified methane or LNG can then be provided to an SMR (50) to produce hydrogen product (60).

The purified methane or LNG stored in the storage vessel (40) can be supplied directly to the SMR (50) if such is located near the landfill, or can be shipped to the SMR (50) site by any suitable means. Alternatively, the purified methane or LNG can be injected into an existing natural gas supply for the SMR.

The present invention provides several advantages. In particular, the creation of green fuels from landfill gas provides benefits to the environment and makes operation of landfills safer. Methane is a potent green house gas and as noted is naturally produced in landfills. By productively using the methane so produced, greenhouse emissions and the threat of global warming are reduced. Further, the use green methane or LNG provides a consistent and inexpensive source of fuel for producing hydrogen in an SMR.

It will be understood that the embodiments described herein are merely exemplary and that one skilled in the art may make variations and modifications without departing from the spirit and scope of the present invention. All such variations and modifications are intended to be included within the scope of the invention as described above. Further, all embodiments disclosed are not necessarily in the alternative, as various embodiments of the invention may be combined to provide the desired result.

What is claimed is:

1. A system for using gas from a landfill for the production hydrogen comprising:
means to collect the gas;
means to purify the gas to produce methane; and
means to provide the methane to a hydrogen production process.

2. The system of claim 1 further comprising means to store the methane.

3. The system of claim 1 wherein the hydrogen production process is a steam methane reformer.

4. The system of claim 1 wherein the methane is provided directly to the hydrogen production process.

5. The system of claim 1 wherein the methane is shipped to the hydrogen production process.

6. The system of claim 1 wherein the methane is injected into a natural gas supply for the hydrogen production process.

7. The system of claim 1 further comprising compressing the methane to obtain liquid natural gas.

8. The system of claim 7 wherein the liquid natural gas is provided directly to the hydrogen production process.

9. The system of claim 7 wherein the liquid natural gas is shipped to the hydrogen production process.

10. The system of claim 7 wherein the liquid natural gas is injected into a natural gas supply for the hydrogen production process.

11. A method for producing hydrogen comprising supplying gas from a landfill to a steam methane reformer to produce the hydrogen.

12. The method of claim 11 wherein the gas is purified methane or liquid natural gas.

13. The method of claim 11 wherein the gas is provided directly to the steam methane reformer.

14. The system of claim 11 wherein the gas is shipped to the steam methane reformer.

15. The system of claim 11 wherein the gas is injected into a natural gas supply for the steam methane reformer.
